(19) United States
(12) Patent Application Publication
(10) Pub. No.: US 2017/0179626 A1
(43) Pub. Date: Jun. 22, 2017

(54) Connector

(71) Applicant: IRISO ELECTRONICS CO., LTD., Yokohama (JP)

(72) Inventor: Kiichi Hori, Yokohama, Kanagawa (JP)

(73) Assignee: IRISO ELECTRONICS CO., LTD., Yokohama (JP)

(21) Appl. No.: 15/366,459

(22) Filed: Dec. 1, 2016

(30) Foreign Application Priority Data
Dec. 22, 2015 (JP) 2015-250699

(51) Int. Cl. H01R 12/71; H01R 13/44; H01R 13/11

(52) U.S. Cl. CPC H01R 12/712; H01R 13/11; H01R 13/44

(57) ABSTRACT

A socket connector includes a first connection terminal and a second connection terminal that come into electrical contact with a plug connector, and a socket housing having an insertion opening for the plug connector. The first connection terminal is provided with a switch contact piece and a terminal body that comes into electrical contact with the plug connector. The switch contact piece has an opening contact point portion that comes into pressure contact with the plug connector, a short-circuit contact point portion, and an elastic arm that elastically supports the opening contact point portion and the short-circuit contact point portion and that is elastically deformed when the opening contact point portion is pressed by the plug connector, and thereby brings the short-circuit contact point portion out of contact with the second connection terminal.

### BACKGROUND OF THE INVENTION

1. Field of the Invention

The present invention relates to a connector that forms different circuits in a fitted state of a connection object and an unfitted state.

2. Description of the Related Art

There is a case where a connection object such as an expansion board is connected to a connector fixed to a circuit board to expand the function of an electrical device. Such a connector can also be used in an unfitted state of the connection object. There is a case where the connection object in a fitted state is extracted and another connection object is fitted. This connector has a plurality of terminals disposed opposite each other. In an unfitted state where the connection object is not connected to the connector, the terminals come into electrical contact with each other to form a short-circuited closed circuit. When fitting the connection object, the closed circuit is opened, and comes into electrical contact with terminals to form another circuit, and a new function can thereby be added (for example, Japanese Unexamined Patent Application Publication No. 53-133790).

In the above-described connector, a pressed portion for opening a closed circuit that is pressed and displaced by a connection object, and a contact point portion for connection to the connection object are provided in the same elastic piece. During the fitting of the connection object, the contact point portion for connection is displaced in conjunction with the pressed portion for opening. Therefore, if the connection object is repeatedly inserted and extracted, the terminal is plastically deformed, and the contact point portion for connection may become difficult to bring into electrical contact with the connection object. This contact point portion for connection also serves as a contact point portion when the terminals come into electrical contact with each other in the unfitted state. Therefore, there is a likelihood that the terminals are plastically deformed away from each other, and it thereby becomes impossible to bring the contact point portions for connection into contact with each other and to form the above closed circuit in the unfitted state of the connection object.

The present invention has been made to solve the above problem. That is, it is an object of the present invention to provide a connector that can reliably perform short-circuit connection of terminals in an unfitted state, and electrical connection with the connection object in a fitted state even after a connection object is repeatedly inserted and extracted.

### SUMMARY OF THE INVENTION

To attain the above object, the present invention is configured as follows.

In an aspect of the present invention, a connector includes a first connection terminal and a second connection terminal that come into electrical contact with a connection object, and a housing having an insertion opening for the connection object. The first connection terminal has a switch contact piece and a terminal body that comes into electrical contact with the connection object. The switch contact piece has an opening contact point portion that comes into pressure contact with the connection object inserted into the housing, a short-circuit contact point portion that comes into electrical contact with the second connection terminal, and an elastic arm that elastically supports the opening contact point portion and the short-circuit contact point portion and that is elastically deformed when the opening contact point portion is pressed by the connection object, and thereby brings the short-circuit contact point portion out of contact with the second connection terminal.

The connector of the present invention has a first connection terminal having a switch contact piece having an opening contact point portion and a short-circuit contact point portion, and a terminal body that comes into electrical contact with a connection object. Therefore, if owing to insertion and extraction of the connection object, the terminal body is repeatedly elastically deformed away from the connection object, the short circuit connection by the switch contact piece is not influenced. In addition, if the switch contact piece is repeatedly elastically deformed away from the connection object, the electrical contact between the terminal body and the connection object is not influenced.

The connector may further include a signal terminal having a contact point portion with the connection object, and the opening contact point portion may be disposed nearer to the insertion opening than the contact point portion in the insertion and extraction direction of the connection object.

In this case, during the insertion of the connection object into the connector of the present invention, first, the connection object comes into contact with the opening contact point portion and brings the short-circuit contact point portion out of contact with the second connection terminal, and then the connection object comes into electrical contact with the signal terminal. Therefore, the connection object can be brought into electrical contact with the signal terminal after the closed circuit is reliably opened.

The switch contact piece may have the opening contact point portion on the distal end side of the short-circuit contact point portion, and may have the elastic arm on the proximal end side of the short-circuit contact point portion.

By doing so, if the opening contact point portion disposed on the distal end side of the switch contact piece is pressed with a small force, the elastic arm provided on the proximal end side of the switch contact piece can be easily elastically deformed by using the principle of leverage. Therefore, the short-circuit contact point portion can be brought out of contact with the second connection terminal with a small force.

The opening contact point portion and the short-circuit contact point portion may be disposed at different positions in a direction intersecting the insertion and extraction direction of the connection object.

By doing so, the connection object comes into contact only with the opening contact point portion and does not come into contact with the short-circuit contact point portion. Therefore, deformation or the like of the short-circuit contact point portion due to the contact of the connection object with the short-circuit contact point portion can be prevented.

The short-circuit contact point portion and the second connection terminal may be in electrical contact with each other in an accommodating portion provided in the housing.

By doing so, a decrease in connection reliability due to the contact of another member with the contact part between the short-circuit contact point portion and the second connection terminal can be prevented.

Since the connector of the present invention has a terminal body and a switch contact piece, the formation and opening of a closed circuit can be switched without interfering with each other. Therefore, the short-circuit connection in the unfitted state can be reliably performed even after the connection object is repeatedly inserted and extracted, and therefore malfunction of the electrical device can be prevented. During the fitting, by ensuring the electrical connection and opening the short-circuit connection, signal connection can be reliably performed.

### BRIEF DESCRIPTION OF THE DRAWINGS

FIG. 1 is a perspective view showing a socket connector of an embodiment.

FIG. 2 is a front view showing the socket connector of FIG. 1.

FIG. 3 is a plan view showing the socket connector of FIG. 1.

FIG. 4 is a bottom view showing the socket connector of FIG. 1.

FIG. 5 is a right side view showing the socket connector of FIG. 1.

FIG. 6 is a perspective view showing the socket terminals of FIG. 1.

FIG. 7 is a back perspective view showing the first connection terminal of FIG. 1.

FIG. 8 is a front perspective view showing the first connection terminal of FIG. 7.

FIG. 9 is a perspective view showing the second connection terminal of FIG. 1.

FIG. 10 illustrates a short-circuit connection structure including the first connection terminal of FIG. 7 and the second connection terminal of FIG. 9.

FIG. 11 is a perspective view of a plug connector that is a fitting counterpart of the socket connector of FIG. 1.

FIG. 12 is a front view showing an unfitted state of the socket connector of FIG. 1 and the plug connector of FIG. 11.

FIG. 13 is a sectional view taken along line XIII-XIII of FIG. 12.

FIG. 14 is a sectional view taken along line XIV-XIV of FIG. 12.

FIG. 15 is a sectional view showing a state where the fitting together of the socket connector and the plug connector is continued further from the state of FIG. 13.

FIG. 16 is a sectional view corresponding to FIG. 14, showing the state of FIG. 15.

FIG. 17 is a sectional view showing a state in which the fitting of the plug connector into the socket connector has been completed.

FIG. 18 is a sectional view corresponding to FIG. 14, showing the state of FIG. 17.

### DESCRIPTION OF THE PREFERRED EMBODIMENTS

A preferred embodiment of a connector of the present invention will be described below with reference to the drawings. In this embodiment, a socket connector 1 attached to an electrical device (not shown) is shown as a “connector.” The socket connector 1 has socket terminals 2 that are soldered to a circuit board P1. A plug connector 3 including plug terminals 4 that are soldered to a circuit board P2 is shown as a “connection object.” The plug connector 3 is used to expand the functions of the electrical device to which the socket connector 1 is attached. By fitting together the socket connector 1 and the plug connector 3, the socket terminals 2 come into electrical contact with the plug terminals 4, and the circuit board P1 is electrically connected to the circuit board P2.

In this specification, the width direction (longitudinal direction) of the socket connector 1 is referred to as X direction, the front-back direction (short side direction) is referred to as Y direction, and the height direction (vertical direction) is referred to as Z direction. The side of the socket connector 1 in the height direction Z is referred to as “lower side,” and the plug connector 3 side is referred to as “upper side.” However, these do not limit the manner in which the socket connector 1 and the plug connector 3 are mounted and used. Because the left side view of the socket connector 1 is symmetrical to the right side view, the depiction thereof is omitted.

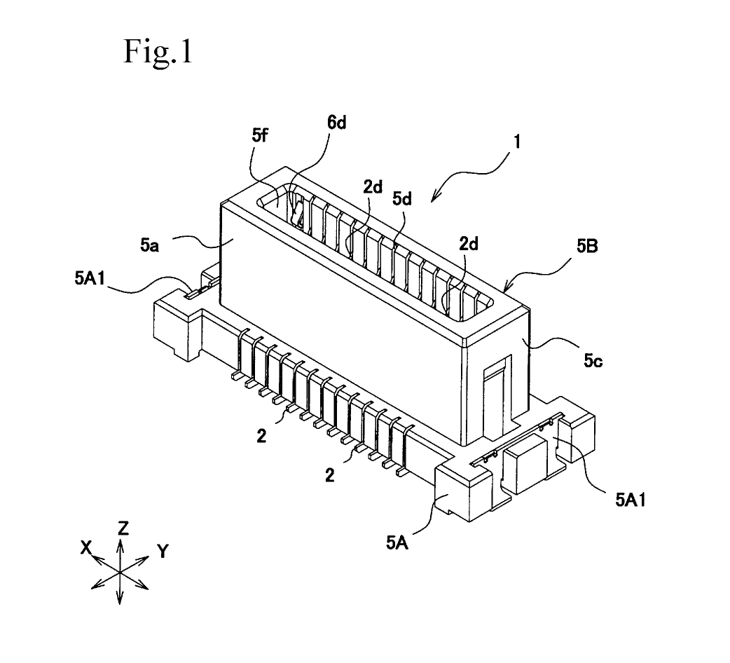

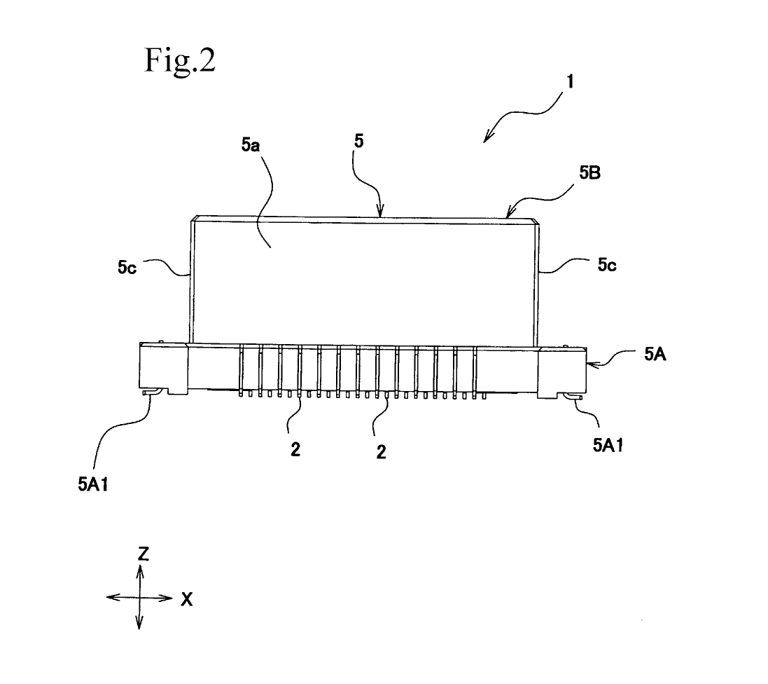

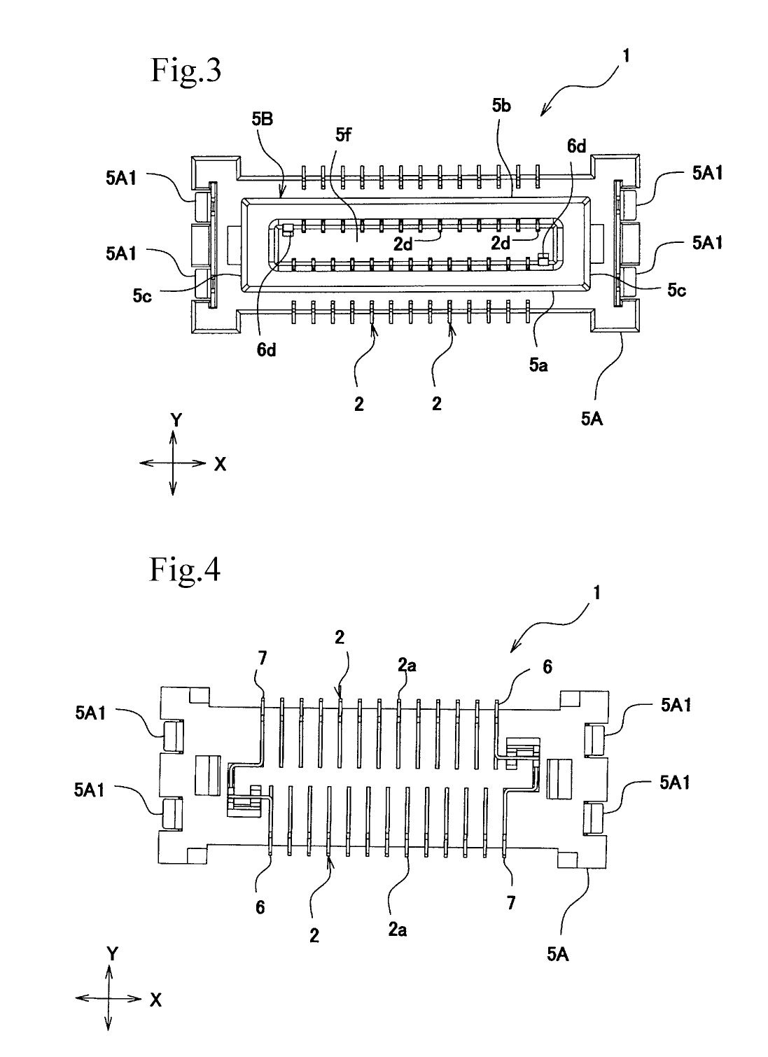

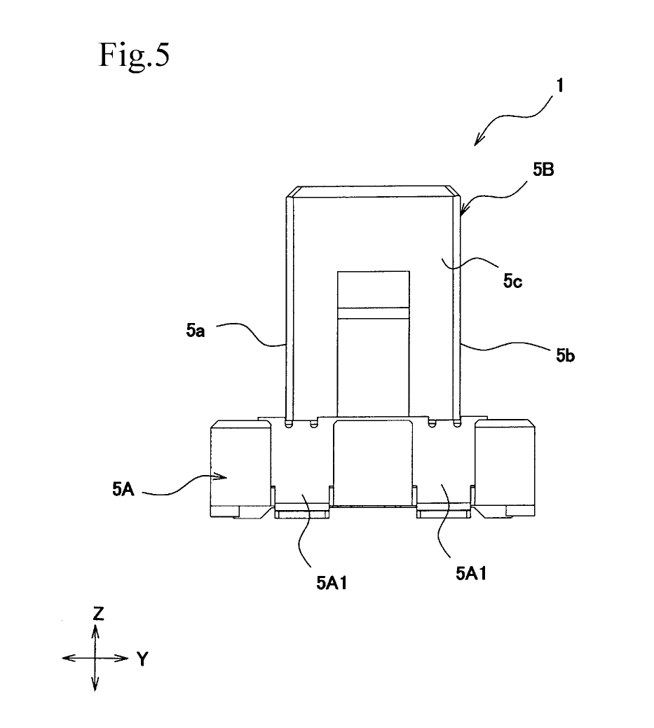

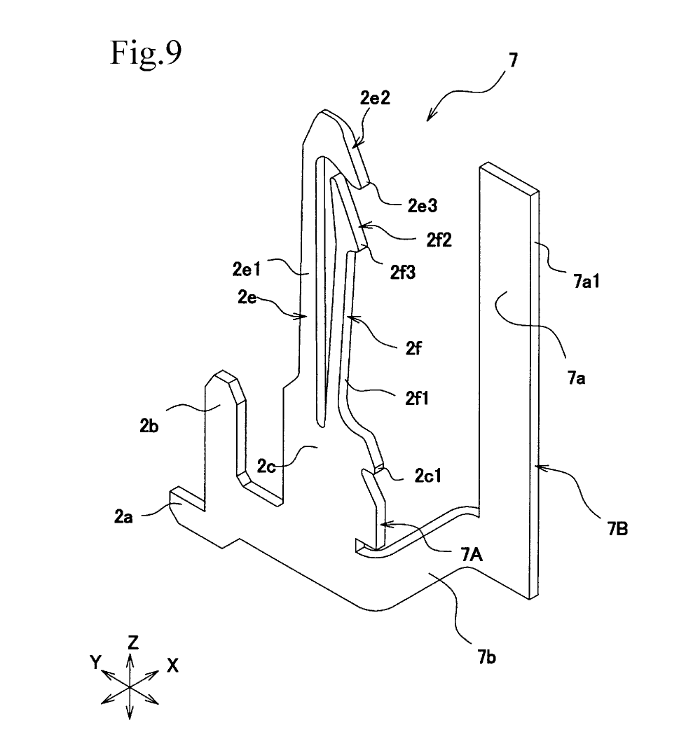

### Embodiment (FIGS. 1 to 18)

### Socket Connector

As shown in FIGS. 1 to 4, the socket connector 1 includes a socket housing 5, a plurality of socket terminals 2, and short-circuit connection structures 1a. The short-circuit connection structures 1a each include a first connection terminal 6 and a second connection terminal 7. The short-circuit connection structures 1a are provided one at each end in the width direction X of the socket housing 5.

### Socket Housing

The socket housing 5 is made of an insulating resin, and is formed in a rectangular parallelepiped shape as shown in FIGS. 1 to 5. The socket housing 5 has a leg portion 5A that is provided on the lower side, and a fitting portion 5B that is provided on the upper side.

Fixing metal fittings 5A1 are provided one at each end in the width direction X of the leg portion 5A. By soldering the fixing metal fittings 5A1 to the circuit board P1, the socket housing 5 is fixed to the circuit board P1.

The fitting portion 5B is substantially a rectangular parallelepiped, and has a front wall portion 5a and a back wall portion 5b that are along the X-Z plane, and side wall portions 5c that have plate surfaces along the Y-Z plane and connect the front wall portion 5a and the back wall portion 5b. The fitting portion 5B further has a fitting chamber 5e surrounded by the front wall portion 5a, the back wall portion 5b, and the side wall portions 5c. An insertion opening 5f into which the plug connector 3 is inserted is provided in the upper surface of the fitting portion 5B.

The front wall portion 5a and the back wall portion 5b are provided with terminal accommodating portions 5d, and the terminal accommodating portions 5d communicate with the fitting chamber 5e. The terminal accommodating portions 5d are disposed in each of the front wall portion 5a and the back wall portion 5b of the socket housing 5, in parallel along the width direction X. The socket terminals 2 are accommodated one in each of the terminal accommodating portions 5d. Because the terminal accommodating portions 5d provided in the front wall portion 5a and the terminal accommodating portions 5d provided in the back wall portion 5b are offset from each other in the width direction X, the socket terminals 2 housed in the respective terminal accommodating portions 5d are arranged in a staggered manner in plan view.

Each side wall portion 5c is provided, on its fitting chamber 5e side, with an accommodating portion 5g that accommodates a short-circuit contact piece 6a of the first connection terminal 6 and a switch piece 7a of the second connection terminal 7 to be described later. The accommodating portion 5g is a space that communicates with the fitting chamber 5e, and is disposed at a different position from the fitting chamber 5e in the width direction X. Therefore, the plug connector 3 can be prevented from coming into contact with the short-circuit contact piece 6a and the switch piece 7a accommodated in the accommodating portion 5g, and deformation or the like due to the contact of them can be suppressed. In addition, foreign matter can be prevented from coming into contact with the short-circuit connection part.

### Socket Terminals

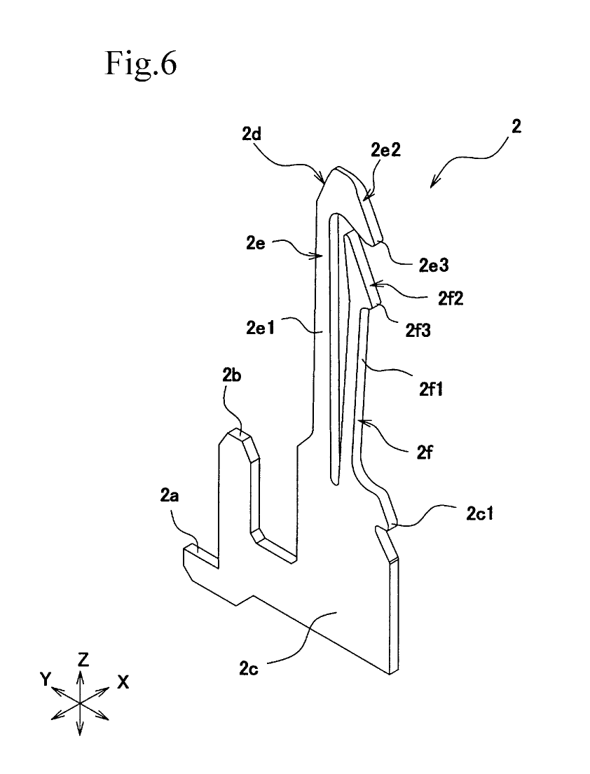

The socket terminals 2 are provided as stamped terminals made by stamping a metal plate as shown in FIG. 6, and are disposed such that the plate surfaces of the metal pieces are along the Y-Z plane. The socket terminals 2 are accommodated one in each of the terminal accommodating portions 5d of the socket housing 5, and are disposed in parallel along the width direction X between two short-circuit connection structures 1a to be described later. The socket terminals 2 each have a circuit board connection portion 2a, a housing fixing portion 2b, a proximal end portion 2c, and a terminal portion 2d.

The circuit board connection portion 2a has a plate edge along the X-Y plane, and is soldered to the circuit board P1.

The housing fixing portion 2b is provided so as to be continuous with the circuit board connection portion 2a, and is a flat plate having substantially rectangular plate surfaces. By press-fitting the housing fixing portion 2b into a fixing hole (not shown) of the socket housing 5, the socket terminal 2 is fixed to the socket housing 5.

The proximal end portion 2c is provided so as to be continuous with the housing fixing portion 2b. The proximal end portion 2c has an engaging portion 2c1 that is fixed to the socket housing 5. The engaging portion 2c1 bites into the inner wall (not shown) of the terminal accommodating portion 5d of the socket housing 5, and the socket terminal 2 is thereby fixed to the housing 5.

The terminal portion 2d extends upward from the upper end of the proximal end portion 2c, and has a front terminal 2e and a rear terminal 2f.

The front terminal 2e has a front elastic piece portion 2e1 and a front contact portion 2e2.

The front elastic piece portion 2e1 is an elongate elastic piece extending upward from the upper end of the proximal end portion 2c.

The front contact portion 2e2 is continuous with the upper end of the front elastic piece portion 2e1. The front contact portion 2e2 protrudes in a V-shape in a direction into contact with a plug contact portion 4a of the plug terminal 4 in a fitted state. This protruding part is provided with a front contact point portion 2e3 that comes into electrical contact with a terminal surface 4a1 of the plug contact portion 4a. During the fitting together of the socket connector 1 and the plug connector 3, the front contact point portion 2e3 comes into sliding contact with the terminal surface 4a1 of the plug contact portion 4a.

The rear terminal 2f has a rear elastic piece portion 2f1 and a rear contact portion 2f2.

The rear elastic piece portion 2f1 is an elongate elastic piece extending upward from the upper end of the proximal end portion 2c. The rear elastic piece portion 2f1 is provided adjacent to the front elastic piece portion 2e1, and is disposed nearer to the fitting chamber 5e than the front elastic piece portion 2e1.

The rear contact portion 2f2 is continuous with the upper end of the rear elastic piece portion 2f1. The rear contact portion 2f2 protrudes in a V-shape toward the plug contact portion 4a of the plug connector 3 in a fitted state. This protruding part is provided with a rear contact point portion 2f3 that comes into electrical contact with the terminal surface 4a1 of the plug contact portion 4a. Because the rear contact point portion 2f3 is disposed below the front contact point portion 2e3 in the fitting direction of the plug connector 3, during the fitting the plug terminal 4 first comes into sliding contact with the front contact point portion 2e3 and then comes into sliding contact with the rear contact point portion 2f3. The rear contact point portion 2f3 and the plug contact portion 4a are disposed along the fitting direction of the plug connector 3, and are disposed at the same position in the width direction X. Therefore, during the fitting of the plug connector 3, the rear contact point portion 2f3 follows the front contact point portion 2e3, and comes into sliding contact with a sliding locus on the terminal surface 4a1 of the plug contact portion 4a.

### First Connection Terminal

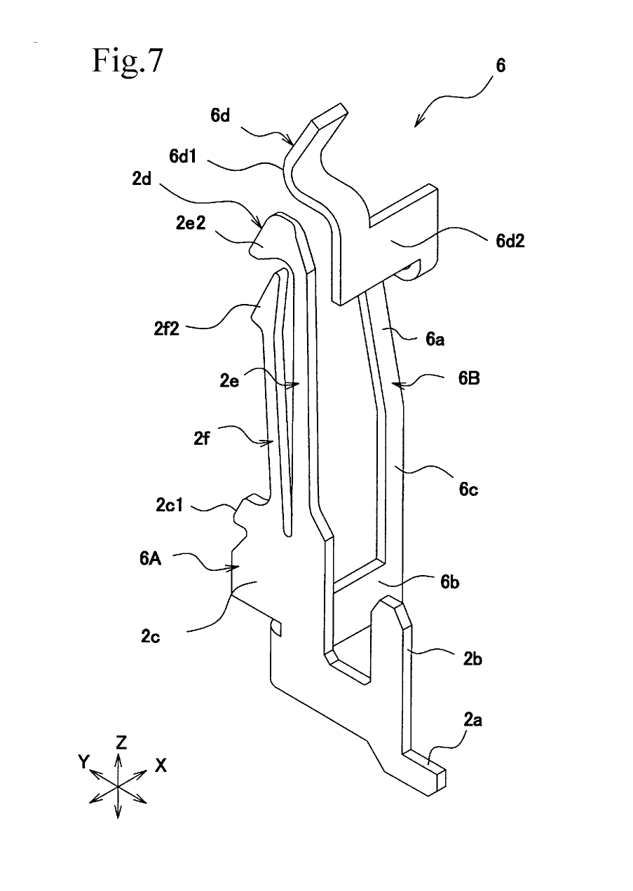

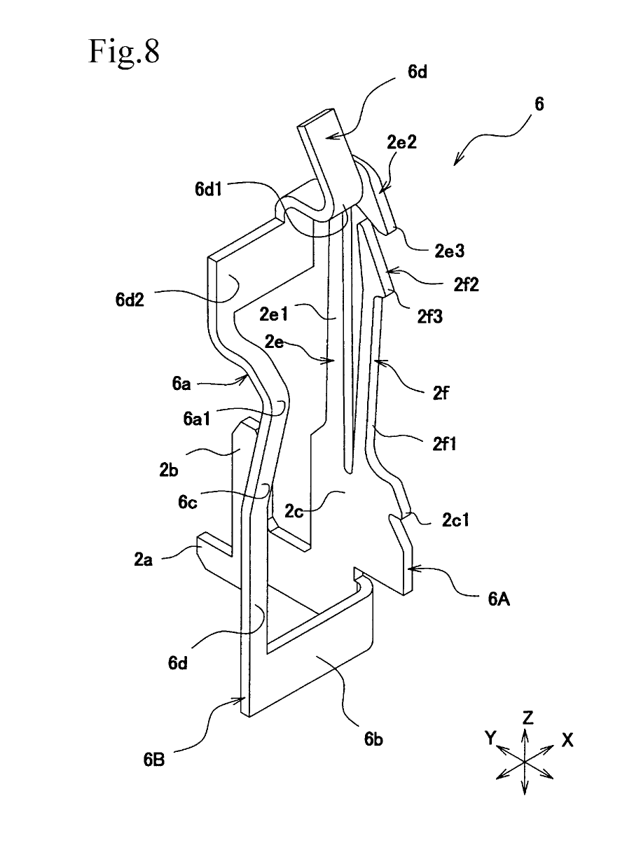

As shown in FIGS. 7 and 8, the first connection terminals 6 are provided one at each of one end in the width direction X of the front wall portion 5a of the socket housing 5 and the other end in the width direction X of the back wall portion 5b. The first connection terminals 6 each have a terminal body 6A and a switch contact piece 6B. As with the socket terminals 2, the terminal body 6A has a circuit board connection portion 2a, a housing fixing portion 2b, a proximal end portion 2c, and a terminal portion 2d.

The switch contact piece 6B has a connecting portion 6b, an elastic arm 6c, a short-circuit contact piece 6a, and an opening contact piece 6d.

The connecting portion 6b is an elongate piece portion extending along the width direction X from the proximal end portion 2c. Owing to such a connecting portion 6b, a short-circuit contact piece 6a to be described later can be disposed at a different position from the terminal body 6A in the width direction X. In addition, the short-circuit contact piece 6a can be accommodated in the accommodating portion 5g provided in the side wall portion 5c of the socket housing 5, with the terminal portion 2d of the terminal body 6A protruding into the fitting chamber 5e. The elastic arm 6c extends upward from the connecting portion 6b, and elastically supports the short-circuit contact piece 6a and the opening contact piece 6d provided at its distal end.

The short-circuit contact piece 6a is a V-shaped elastic piece that protrudes toward the switch piece 7a of the second connection terminal 7 disposed opposite thereto. The short-circuit contact piece 6a has, at its apex, a short-circuit contact point portion 6a1 that comes into electrical contact with the switch piece 7a. The short-circuit contact piece 6a is accommodated in the accommodating portion 5g provided in the side wall portion 5c of the socket housing 5, and does not protrude into the fitting chamber 5e.

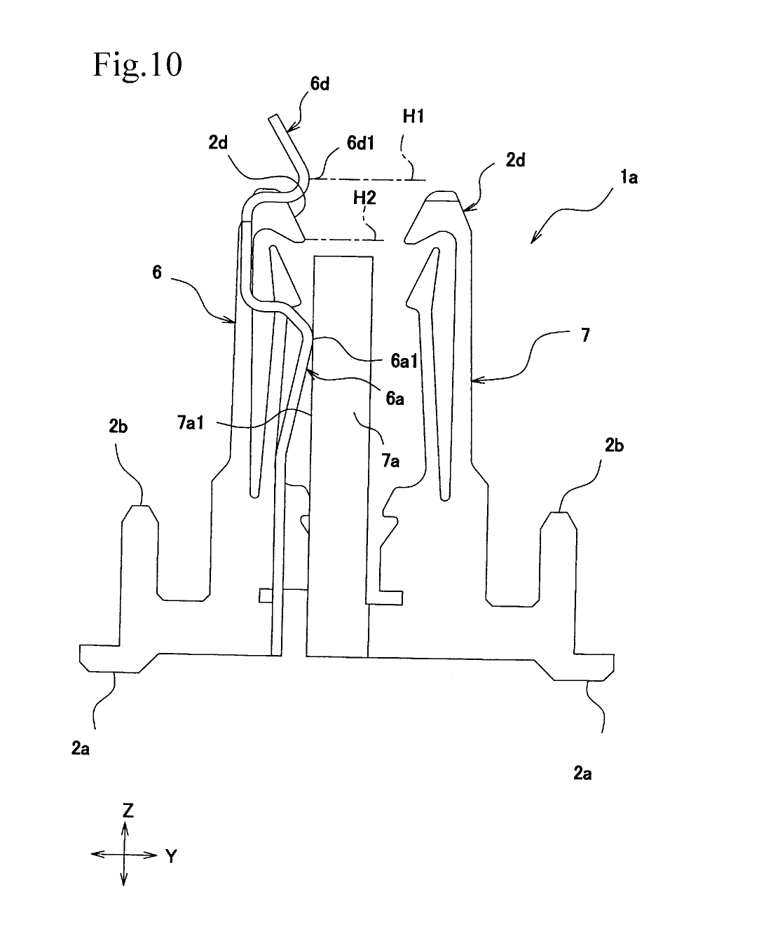

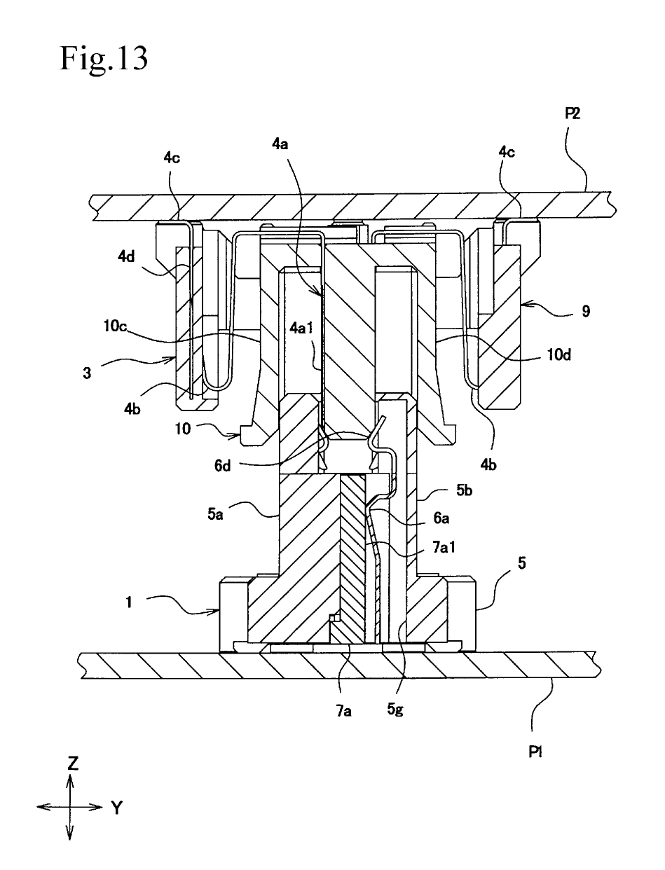

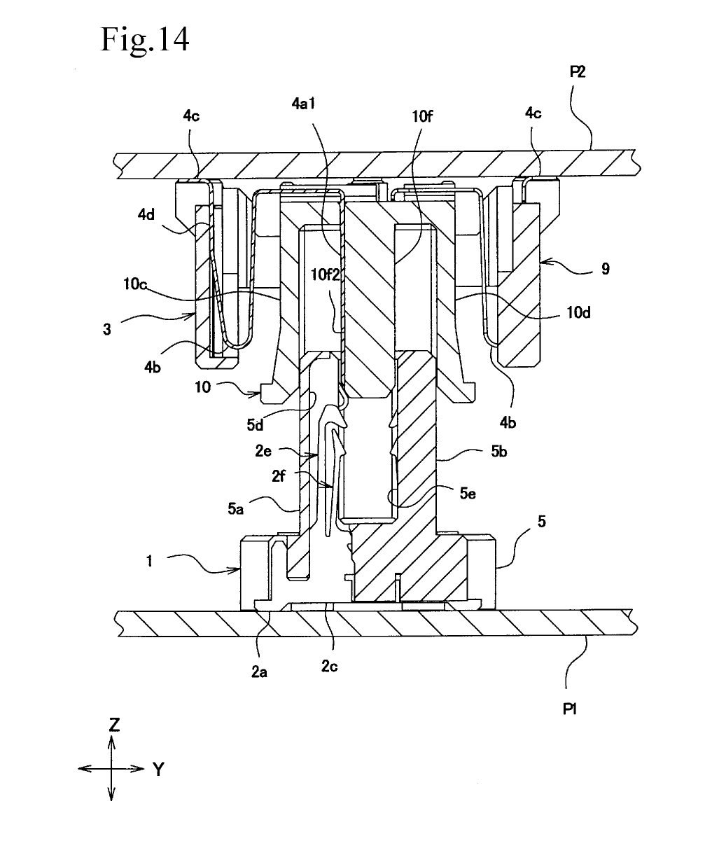

The opening contact piece 6d is disposed above the short-circuit contact piece 6a. The opening contact piece 6d has an opening contact point portion 6d1 having a V-shape, and a connecting piece 6d2 that connects the short-circuit contact piece 6a and the opening contact point portion 6d1. The connecting piece 6d2 extends along the width direction X, and the opening contact piece 6d can thereby be protruded from the accommodating portion 5g of the side wall portion 5c into the fitting chamber 5e. The height position of the opening contact point portion 6d1 (H1 of FIG. 10) is disposed above the height position of the terminal portions 2d of the socket terminal 2, the first connection terminal 6, and the second connection terminal 7 (H2 of FIG. 10) in the height direction Z. By doing so, during the fitting of the plug connector 3, a pressing portion 10f1 of a plug housing 8 comes into pressure contact with the opening contact piece 6d before the plug terminals 4 of the plug connector 3 come into contact with the terminal portions 2d (FIGS. 13 and 14). The short-circuit contact piece 6a and the opening contact piece 6d are supported by the same elastic arm 6c at its distal end. Therefore, by elastically deforming the elastic arm 6c, the short-circuit contact piece 6a and the opening contact piece 6d can be elastically displaced in conjunction with each other.

Since the terminal body 6A and the switch contact piece 6B are connected with the connecting portion 6b on the side of the circuit board P1, the terminal body 6A and the switch contact piece 6B can be deformed independently from each other. Therefore, if the terminal body 6A is repeatedly elastically deformed owing to the insertion and extraction of the plug connector 3, a situation where the switch contact piece 6B is influenced by it and becomes difficult to bring into electrical contact with a switch portion 7B is less likely to arise. In addition, if the switch contact piece 6B is repeatedly elastically deformed owing to the insertion and extraction of the plug connector 3, a situation where the terminal body 6A is influenced by it and becomes difficult to bring into electrical contact with the connection object is less likely to arise. Since the first connection terminal 6 includes the terminal body 6A that comes into electrical contact with the plug contact portion 4a, and the switch contact piece 6B, the number of parts can be reduced compared to a case where the terminal body 6A and the switch contact piece 6B are provided as separate members.

### Second Connection Terminal

As shown in FIG. 10, the second connection terminal 7 forms a short-circuit connection structure 1a together with the first connection terminal 6. The second connection terminals 7 are provided one at each of one end in the width direction X of the front wall portion 5a and the other end in the width direction X of the back wall portion 5b. The second connection terminals 7 each have a terminal body 7A and a switch portion 7B. The terminal body 7A has a circuit board connection portion 2a, a housing fixing portion 2b, a proximal end portion 2c, and a terminal portion 2d that have the same structure as the socket terminal 2.

The switch portion 7B has a connecting portion 7b and a switch piece 7a. The connecting portion 7b is an elongate piece portion extending along the width direction X from the proximal end portion 2c. The switch piece 7a is provided so as to be continuous with the connecting portion 7b, and is a plate-like piece along the Y-Z plane. Owing to the connecting portion 7b, the switch piece 7a is disposed at a different position from the terminal body 7A in the width direction X. In addition, the switch piece 7a can be accommodated in the accommodating portion 5g provided in the side wall portion 5c of the socket housing 5, with the terminal body 7A disposed in the fitting chamber 5e. In this embodiment, a plate edge portion 7a1 of the switch piece 7a comes into electrical contact with the short-circuit contact point portion 6a1 of the first connection terminal 6.

Since the terminal body 7A and the switch piece 7a are connected with the connecting portion 7b on the side of the circuit board P1, the terminal body 7A can be elastically deformed independently from the switch portion 7B. Therefore, if the terminal body 7A is repeatedly elastically deformed owing to the insertion and extraction of the plug connector 3, a situation where the switch piece 7a thereby becomes difficult to bring into electrical contact with the switch contact piece 6B is less likely to arise. Since the second connection terminal 7 including the terminal body 7A that comes into electrical contact with the plug contact portion 4a, and the switch piece 7a is provided, the number of parts can be reduced compared to a case where the terminal body 7A and the switch piece 7a are provided as separate members.

### Plug Connector

The plug connector 3 is a floating connector including a plug housing 8 and plug terminals 4.

### Plug Housing

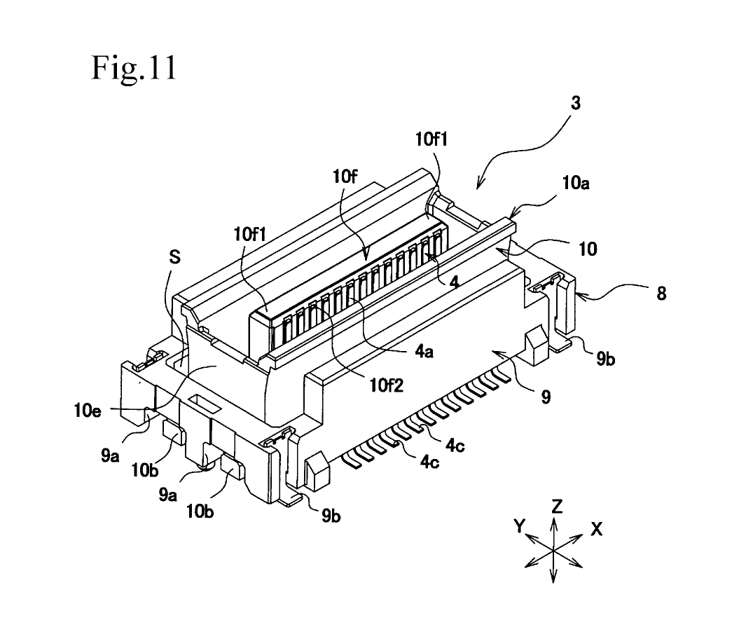

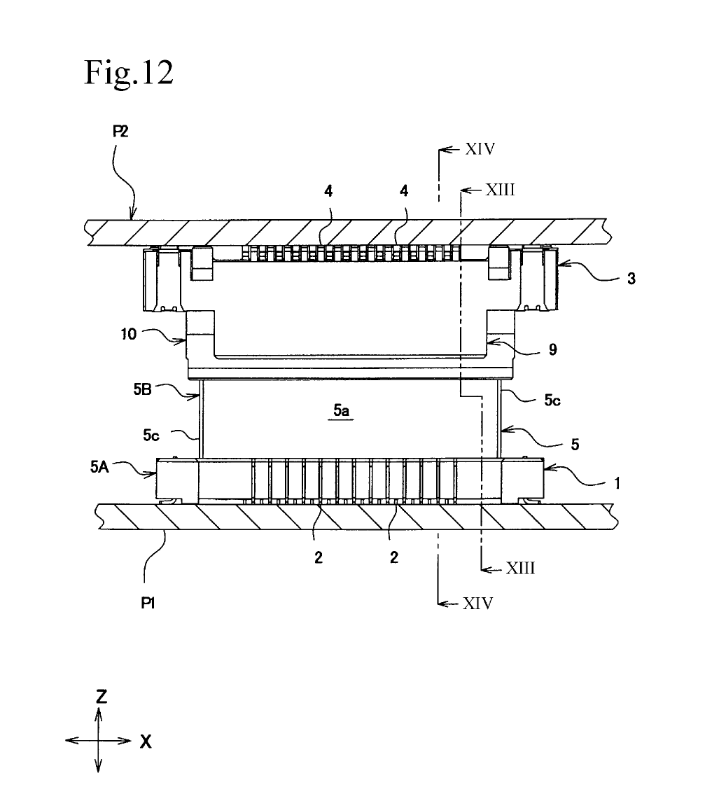

As shown in FIGS. 11 and 12, the plug housing 8 includes a stationary housing 9 and a movable housing 10.

### Stationary Housing

The stationary housing 9 is made of an insulating resin, and has a frame shape that surrounds the outer peripheral surface of the movable housing 10. A movable space S in which the movable housing 10 is movable is formed between the stationary housing 9 and the movable housing 10. Housing fixing portions 4d of the plug terminals 4 to be described later are fixed to the stationary housing 9. The stationary housing 9 is provided with engaging recessed portions 9a with which the movable housing 10 is engaged, and fixing metal fittings 9b that are soldered to the circuit board P2.

### Movable Housing

The movable housing 10 is made of an insulating resin, and is held displaceably relative to the stationary housing 9. The movable housing 10 can be displaced in the movable space S of the stationary housing 9, relative to the stationary housing 9. The movable housing 10 has a housing body 10a that is fitted into the socket connector 1.

The housing body 10a has a front wall portion 10c, a back wall portion 10d, side wall portions 10e, and a fitting wall 10f.

The front wall portion 10c and the back wall portion 10d have plate surfaces along the X-Z plane. The front wall portion 10c has accommodating portions (not shown) that accommodate the plug terminals 4. The side wall portions 10e connect the front wall portion 10c and the back wall portion 10d, and have plate surfaces along the Y-Z plane.

The side wall portions 10e have engaging portions 10b that engage with the stationary housing 9. The engaging portions 10b are provided, two on each of the side wall portions 10e, along the front-back direction Y, and are accommodated in the engaging recessed portions 9a of the stationary housing 9.

The fitting wall 10f is provided between the front wall portion 10c and the back wall portion 10d, and has plate surfaces along the X-Z plane. Pressing portions 10f1 that press the opening contact point portions 6d1 of the first connection terminals 6 of the socket connector 1 are provided on the top surface of the fitting wall 10f and at both ends in the width direction X. Terminal grooves 10f2 to which the plug contact portions 4a of the plug terminals 4 are fixed are provided in a plate surface of the fitting wall 10f that faces the front wall portion 10c and a plate surface of the fitting wall 10f that faces the back wall portion 10d.

### Plug Terminals

The plug terminals 4 are formed by bending metal pieces formed by stamping a metal plate. As shown in FIGS. 14, 16, and 18, the plug terminals 4 each have a circuit board connection portion 4c, a housing fixing portion 4d, a movable portion 4b, and a plug contact portion 4a.

The circuit board connection portion 4c has a flat, substantially rectangular plate surface. The circuit board connection portion 4c is soldered to the circuit board P2, with this substantially rectangular plate surface in contact with the circuit board surface of the circuit board P2.

The housing fixing portion 4d is fixed to the inside of a holding groove (not shown) provided in the stationary housing 9.

The movable portion 4b is provided as an elongate metal piece that extends from the housing fixing portion 4d. The movable portion 4b has a substantially U-shape, is continuous at one end with the circuit board connection portion 4c, and is continuous at the other end with the plug contact portion 4a to be described later. When vibration, shock, or the like is applied to the plug connector 3, the movable portion 4b is elastically displaced in the width direction X or the front-back direction Y, and the movable housing 10 can thereby be displaced relative to the stationary housing 9.

The plug contact portion 4a has a plate surface along the X-Z plane. The plug contact portion 4a has engaging protrusions (not shown) at both ends in the width direction X, and is press-fitted and fixed to one of terminal grooves 10f2 provided in both the front side and back side surfaces of the fitting wall 10f.

### How to Open Closed Circuit

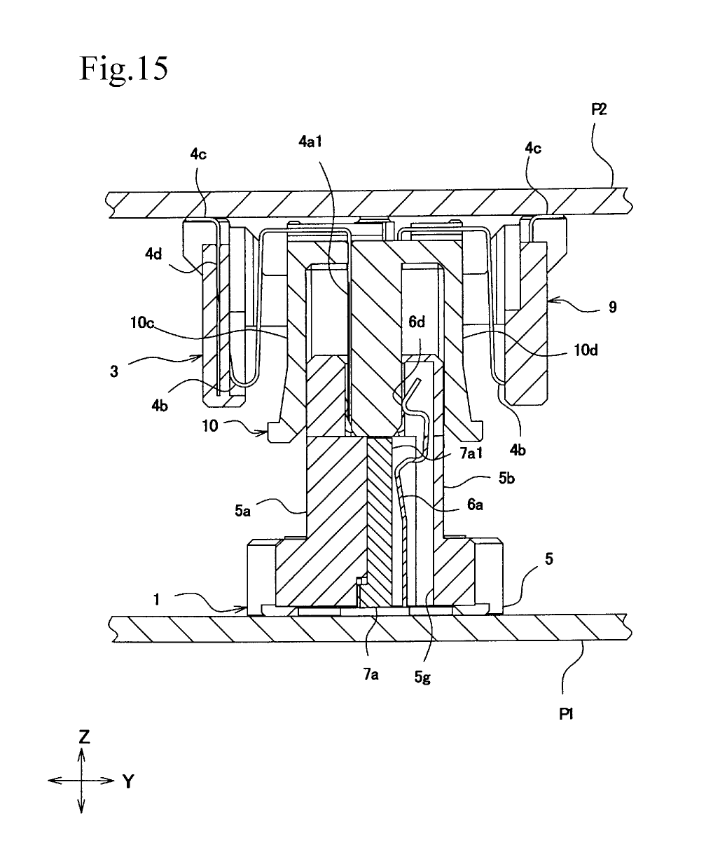

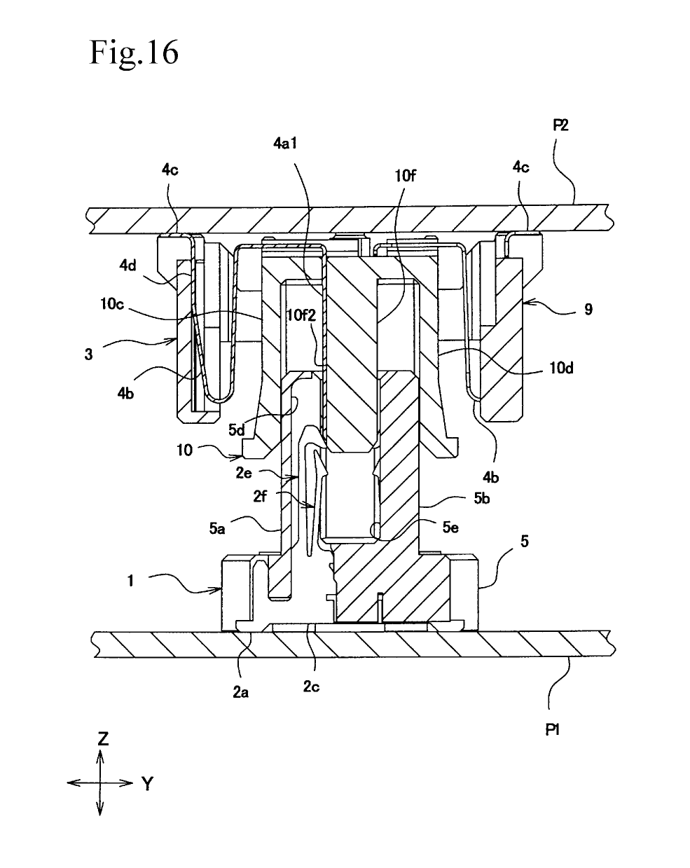

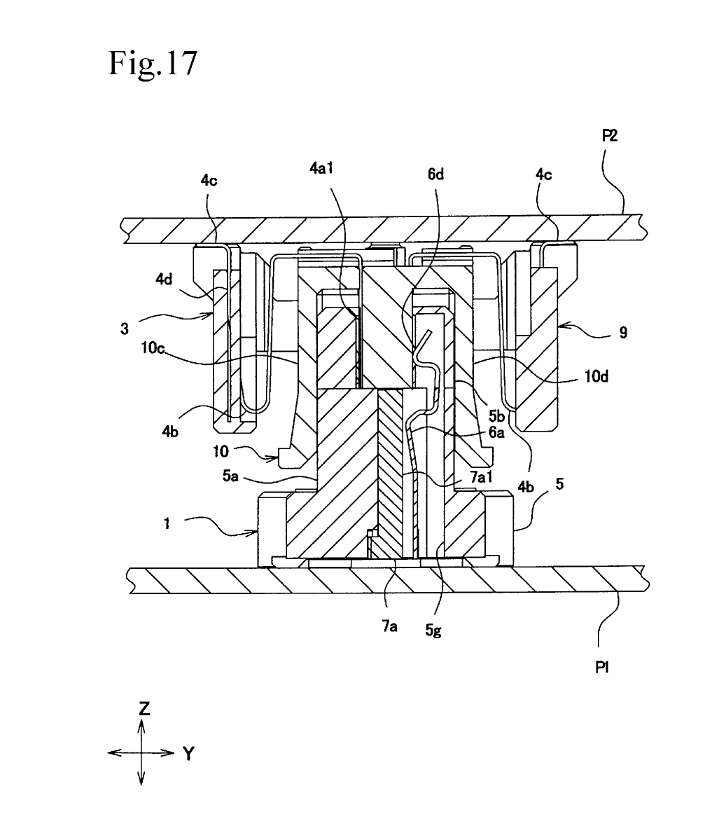

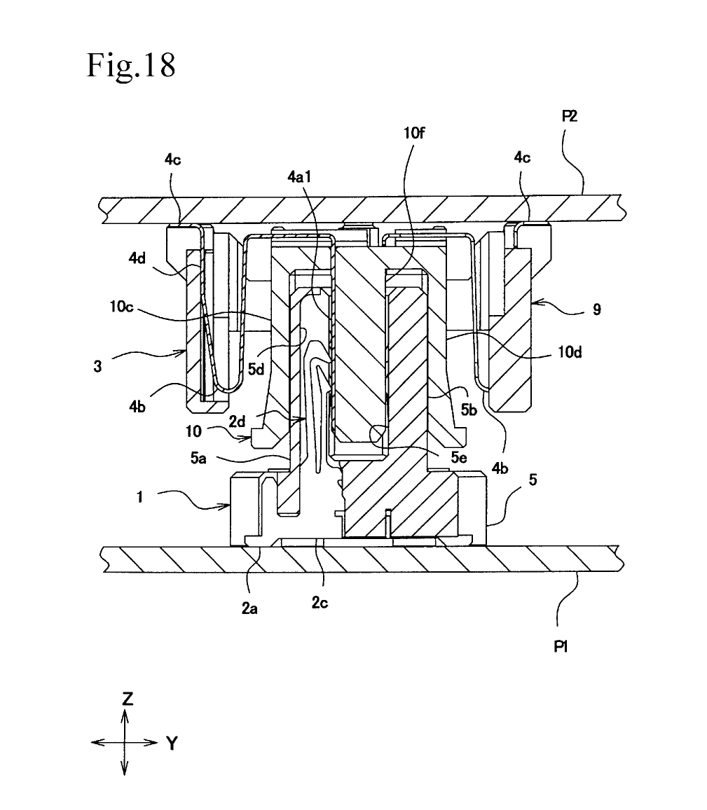

How to use the socket connector 1 of this embodiment will be described. FIGS. 13 and 14, FIGS. 15 and 16, and FIGS. 17 and 18 are sectional views each showing the same stage in the process of fitting together of the socket connector 1 and the plug connector 3. That is, FIGS. 13 and 14 show an unfitted state, FIGS. 15 and 16 show a half-fitted state, and FIGS. 17 and 18 show a fitted state.

The socket connector 1 is fixed to the circuit board P1, and the plug connector 3 is fixed to the circuit board P2. As shown in FIGS. 10, 13, and 14, in a state where the plug connector 3 is not fitted, the short-circuit contact point portion 6a1 of the first connection terminal 6 provided in the socket connector 1 is in electrical contact with the plate edge portion 7a1 of the switch piece 7a of the second connection terminal 7. Therefore, in this unfitted state, a closed circuit in which the circuit board P1, the first connection terminal 6, and the second connection terminal 7 are short-circuited is formed.

In that state, the plug connector 3 is inserted through the insertion opening 5f provided in the socket connector 1, into the inside of the fitting chamber 5e. As shown in FIGS. 15 and 16, during the fitting of the plug connector 3, the pressing portion 10f1 of the plug housing 8 presses the opening contact point portion 6d1 of the first connection terminal 6 provided in the socket connector 1, in the inside of the fitting chamber 5e. The elastic arm 6c is elastically deformed, and the opening contact piece 6d are thereby elastically displaced away from the plug contact portion 4a. Thereby, the short-circuit contact point portion 6a1 disposed between the opening contact point portion 6d1 and the elastic arm 6c is also elastically displaced away from the plug connector 3 in the front-back direction Y. The switch contact piece 6B has the short-circuit contact piece 6a at its proximal end, and the opening contact piece 6d at its distal end. Therefore, if the opening contact point portion 6d1 at the distal end is pressed with a smaller force, the elastic arm 6c can be easily elastically deformed by using the principle of leverage. Thus, the short-circuit contact point portion 6a1 comes out of contact with the plate edge portion 7a1 of the switch piece 7a of the second connection terminal 7. Thereby, the closed circuit formed by the circuit board P1, the first connection terminal 6, and the second connection terminal 7 can be opened. In this state, the opening contact piece 6d is pressed by the fitting wall 10f of the plug housing 8, the elastic arm 6c is thereby elastically deformed, and restoring force toward the fitting wall 10f acts.

Thereafter, the fitting together of the socket connector 1 and the plug connector 3 is further continued. The opening contact piece 6d is disposed above the terminal portion 2d of the socket terminal 2 in the height direction Z. Therefore, after the pressing portion 10f1 of the plug housing 8 comes into contact with the opening contact piece 6d and the above closed circuit is reliably opened, the plug contact portion 4a of the plug terminal 4 comes into electrical contact with the terminal portion 2d of the socket terminal 2. Since the opening contact piece 6d is thus disposed, the electrical continuity between the circuit board P1 and the circuit board P2 can be established after the above closed circuit is reliably disconnected. Therefore, the formation of an unintended circuit, such as that in which the electrical continuity between the circuit boards P1 and P2 is established although the closed circuit is not opened, can be prevented.

Since the front contact portion 2e2 of the front terminal 2e is disposed above the rear contact portion 2f2 of the rear terminal 2f in the height direction Z, the front contact portion 2e2 comes into electrical contact with the plug contact portion 4a first, and then the rear contact portion 2f2 comes into electrical contact with the plug contact portion 4a (FIGS. 16 and 18). Thus, the fitting together of the socket connector 1 and the plug connector 3 is completed. A new circuit is thereby formed by the circuit board P1, the socket terminal 2, the plug terminal 4, and the circuit board P2.

In this embodiment, as described above, the socket terminals 2 each have a front contact point portion 2e3 and a rear contact point portion 2f3, and a foreign matter removing function is thereby provided. Specifically, during the fitting, the front contact point portion 2e3 comes into sliding contact with the terminal surface 4a1 of the plug contact portion 4a, and then the rear contact point portion 2f3 comes into electrical contact with a sliding locus thereof. Therefore, the front contact point portion 2e3 wipes the terminal surface 4a1 of the plug contact portion 4a to remove foreign matter, so that the rear contact point portion 2f3 can come into electrical contact with the sliding locus of the front contact point portion 2e3 from which foreign matter is removed. Therefore, the rear contact point portion 2f3 can reliably come into electrical contact with the plug contact portion 4a, and therefore the socket terminal 2 has higher connection reliability.

### How to Re-Form Closed Circuit

When the plug connector 3 is extracted from the fitting chamber 5e of the socket connector 1, first, the plug terminals 4 come out of contact with the socket terminals 2, and the circuit that electrically connects the circuit board P1 and the circuit board P2 is thereby opened. Thereafter, the extracting operation is further continued, and the pressing portions 10f1 of the plug connector 3 thereby come out of contact with the opening contact portions 6d1 of the first connection terminals 6 of the socket connector 1. Thereby, the above restoring force elastically deforms the elastic arms 6c toward the switch pieces 7a of the second connection terminals 7 in the front-back direction Y. Accordingly, the short-circuit contact pieces 6a are also elastically deformed likewise, and come into electrical contact with the plate edge portions 7a1 of the switch pieces 7a of the second connection terminals 7. Thus, a closed circuit between the circuit board P1, the first connection terminal 6, and the second connection terminal 7 is re-formed.

Thus, by inserting and extracting the plug connector 3 into and from the socket connector 1, the short-circuit contact pieces 6a of the first connection terminals 6 can be displaced toward and away from the second connection terminals 7 to form the above closed circuit, and to open the closed circuit and establish a circuit between the circuit board P1 and the circuit board P2. Therefore, it is possible to usually use only the above closed circuit, and to fit the plug connector 3 fixed to the circuit board P2 into the socket connector 1 only when the function of a product is desired to be expanded. When that function is no longer required, the plug connector 3 can be extracted from the socket connector 1 to establish the original closed circuit.

Since, as described above, the socket connector 1 of this embodiment is provided with the first connection terminal 6 and the second connection terminal 7, in the fitted state, signal connection can be reliably performed by ensuring the electrical connection between the socket terminals 2 and the plug terminals 4 and opening the short-circuit connection, and in the unfitted state, the short-circuit connection can be reliably performed. In addition, since the first connection terminal 6 has the terminal body 6A and the switch contact piece 6B that elastically displaced independently from each other, the formation and opening of the closed circuit can be performed even after the plug connector 3 is repeatedly inserted and extracted.

### Modifications of Embodiment

The socket terminals 2 of the above-described embodiment each have a plurality of contact point portions: a front contact point portion 2e3 and a rear contact point portion 2f3. The front contact point portion 2e3 wipes the terminal surface 4a1 of the plug contact portion 4a to remove foreign matter, and the rear contact point portion 2f3 comes into electrical contact with that part. Alternatively, the socket terminals 2 may each have only one contact point portion. By doing so, the cost of material can be reduced.

In the above-described embodiment, the opening contact point portion 6d1 is disposed above the terminal portions 2d of the socket terminals 2 in the height direction Z and close to the insertion opening 5f for the socket housing 5. Therefore, the electrical contact between the first connection terminal 6 and the second connection terminal 7 is reliably disconnected to open the closed circuit, and then the terminal portion 2d of the socket terminal 2 is brought into electrical contact with the plug contact portion 4a. Alternatively, the opening contact point portion 6d1 may be disposed below the terminal portions 2d of the socket terminals 2 in the height direction Z and at a position distant from the insertion opening 5f. In this case, the pressing portions 10f1 of the plug housing 8 may be extended below the terminal portion 2d of the socket terminals 2 in the height direction Z so that the pressing portions 10f1 press the opening contact piece 6d before the terminal portion 2d of the socket terminals 2 come into electrical contact with the plug contact portion 4a.

What is claimed is:

1. A connector comprising:
a first connection terminal and a second connection terminal that come into electrical contact with a connection object; and
a housing having an insertion opening for the connection object,
wherein the first connection terminal has
a switch contact piece having
an opening contact point portion that comes into pressure contact with the connection object inserted into the housing,
a short-circuit contact point portion that comes into electrical contact with the second connection terminal, and
an elastic arm that elastically supports the opening contact point portion and the short-circuit contact point portion and that is elastically deformed when the opening contact point portion is pressed by the connection object, and thereby brings the short-circuit contact point portion out of contact with the second connection terminal, and
a terminal body that comes into electrical contact with the connection object.

2. The connector according to claim 1, further comprising a signal terminal having a contact point portion with the connection object, and wherein the opening contact point portion is disposed nearer to the insertion opening than the contact point portion in the insertion and extraction direction of the connection object.

3. The connector according to claim 1, wherein the switch contact piece has the opening contact point portion on the distal end side of the short-circuit contact point portion, and has the elastic arm on the proximal end side of the short-circuit contact point portion.

4. The connector according to claim 2, wherein the opening contact point portion and the short-circuit contact point portion are disposed at different positions in a direction intersecting the insertion and extraction direction of the connection object.

5. The connector according to claim 3, wherein the opening contact point portion and the short-circuit contact point portion are disposed at different positions in a direction intersecting the insertion and extraction direction of the connection object.

6. The connector according to claim 1, wherein the short-circuit contact point portion and the second connection terminal are in electrical contact with each other in an accommodating portion provided in the housing.
